(19) United States
(12) Patent Application Publication
(10) Pub. No.: US 2002/0126355 A1
(43) Pub. Date: Sep. 12, 2002

(54) Dispersion compensation of higher-order optical signal distortion

(75) Inventor: Henning Bulow, Kornwestheim (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/074,001

(22) Filed: Feb. 14, 2002

(30) Foreign Application Priority Data
Mar. 7, 2001 (DE) 101 10 853.2

(51) Int. Cl. H04B 10/00; H04B 10/12

(52) U.S. Cl. 359/161; 359/173

(57) ABSTRACT

An arrangement and a method are disclosed for compensating for distortion in an optical signal having data modulated thereon which was caused by distortion effects on an optical fiber link, using a dispersion compensator which processes the incoming optical signal such that an optical or electric signal having the data of the input signal modulated thereon is provided at its output, with the output signal of the dispersion compensator exhibiting a distortion reduced from that of the input signal. The arrangement and the method are characterized in that the dispersion compensator is preceded by an optical bandpass filter which limits the spectral range of the incoming optical signal to a narrower range. In this way, even optical signal distortion due to higher-order dispersion effects can be selectively compensated for with simple technical means such that greater link lengths and more reliable adaptation to varying transmission conditions become possible.

### BACKGROUND OF THE INVENTION

The invention is based on a priority application DE 101 10 853.2 which is hereby incorporated by reference.

This invention relates to a method of and an arrangement for compensating for distortion in an optical signal having data modulated thereon which was caused by dispersion effects on an optical fiber link, with a dispersion compensator which processes the incoming optical signal such that an optical or electric signal having the data of the input signal modulated thereon is provided at its output, with the output signal of the dispersion compensator exhibiting a distortion reduced from that of the input signal.

Such methods and arrangements are known, for example, from a paper by H. Bülow, “PMD mitigation techniques and their effectiveness in installed fiber”, Techn. Dig. OFC 2000, ThHl, Mar. 9, 2000.

Today, signals, particularly data signals, are frequently transmitted using electromagnetic waves in the frequency region of visible light. As is known per se from radio engineering, a data signal is modulated onto a carrier signal. On the optical fiber link, which generally comprises mirrors, optical fibers, and other dispersive elements, distortions occur in the transmitted optical signal which may result in corruption of or errors in the data being transmitted. Such distortions arise from chromatic dispersion or polarization mode dispersion (=PMD), for example.

In systems with 40G channel-rate transmission over link lengths of several hundred kilometers, for example, optical communication network operators are already today using very many optical fibers with such high PMD that such dispersion compensation with the above-described features is indispensable. This dispersion compensation is usually implemented with a dispersion compensator installed in the transmission network at the receiving end.

In an article by L. Moller, “Broadband PMD Compensation in WDM Systems”, Proc. ECOC 2000, September 2000, for example, a PMD compensator is described which can compensate for at least part of the distortion caused by PMD effects.

With these prior-art compensators, only first-order or at best lower-order effects can be processed.

Simple arrangements as are described, for example, in F. Heismann et al, “Automatic Compensation of First-Order Polarization Mode Dispersion in a 10 Gb/s Transmission System”, Proc. ECOC'98, WdCl 1, 1998, and in F. Roy et al, “A Simple Dynamic Polarization Mode Dispersion Compensator”, Techn. Dig. OFC/IOOC'99, 1999, TuS4, compensate only for first-order PMD. With that, a fiber PMD of about 35% of the bit duration at the most can be compensated for. This value (35 ps for 10 Gb/s) will be too small particularly in 40-Gb/s systems, since it means a PMD of only 8.8 ps.

If this PMD limit value is exceeded, higher-order distortions will occur as well. First compensators also for higher PMD orders are described in the above-cited article by L. Möller, for example. On the one hand, it is apparent that the amount of signal processing circuitry required increases rapidly with increasing orders, and on the other hand, sufficiently fast adaptation of such an arrangement with many arbitrary parameters is not ensured.

### SUMMARY OF THE INVENTION

It is an object of the present invention to improve a method and an arrangement of the above kind with the simplest possible means in such a way that even distortions of optical signals in optical signal transmission systems which are caused by higher-order dispersion effects can be selectively compensated for with a minimum amount of technical complexity so as to permit greater link lengths and more reliable adaptation to varying transmission conditions.

According to the invention, this object is attained in a simple and effective manner by connecting ahead of the dispersion compensator an optical bandpass filter which limits the spectral range of the incoming optical signal to a narrower range.

The bandpass filter preceding the dispersion compensator in accordance with the invention provides to the compensator an optical signal in which spectral components that exhibit higher-order distortions can be selectively cut off. This permits the level of technical complexity of the dispersion compensator to be substantially reduced with unchanged equalization performance. In adaptive compensators, the adaptation time is shortened considerably by the use of the bandpass filter.

If the optical bandpass filter is suitably chosen, it can be ensured that no data information modulated on the transmitted optical signal will be lost. Spectral components distorted by higher-order dispersion effects can be blocked out in a highly efficient manner. In this way, substantially longer optical fiber elements can be used in optical information transmission systems at 40G and above because of the higher-order dispersion compensation and the fast adaptability of the compensator made possible by the prefiltered input signal. In particular, the simple optical prefiltering of the incoming signal prior to the dispersion compensation proper permits an otherwise necessary complicated dynamic higher-order equalization to be reduced to a first-order or at least lower-order equalization.

In a preferred embodiment of the arrangement according to the invention, the optical bandpass filter is a vestigial-sideband filter which posses only one sideband and the carrier component of the optical signal. This is particularly advantageous if standard dual-sideband spectra with NRZ (=non-return-to-zero) signals are used. The output signal from the vestigial-sideband filter has a substantially narrower optical bandwidth, but the data modulated thereon are left unaffected. As a result, spectral components that are severely distorted by higher-order dispersion modes can be filtered out of the signal without loss of information, which greatly facilitates the subsequent equalization in the dispersion compensator.

According to a preferred development of this embodiment, the bandwidth of the vestigial-sideband filter corresponds to approximately half the bit rate of the data modulated on the optical signal. This allows a minimum filter bandwidth to be used which causes just no loss of information or no distortion in the processed optical signal.

In embodiments of the invention, the dispersion compensator can compensate for distortion caused by chromatic dispersion, as is known per se, for example, from B. J. Eggleton et al, “Tunable Dispersion Compensation in a 160 Gb/s TDM System by Voltage Controlled Fiber Grating”, or from S. T. Vohra et al, “Dynamic Dispersion Compensation Using Bandwidth Tunable Fiber Bragg Gratings”, both articles published in Proc. ECOC 2000, September 2000, Vol. 1, pp. 111-114.

Particularly at data rates of 160 Gb/s and above, which are envisaged for the future, higher-order chromatic dispersion (dispersion slope) lead to appreciable signal degradation (see Eggleton et al), which must be compensated for. Also, even slight changes in ambient temperature cause a variation in fiber dispersion, so that continuous adaptive control of the chromatic dispersion compensator becomes indispensable. With the bandpass filter connected ahead of the dispersion compensator in accordance with the invention, such distortion caused by higher-order dispersion effects can be compensated for with a very small amount of technical complexity.

In another preferred embodiment of the invention, the dispersion compensator is a PMD (=polarization mode dispersion) compensator. This permits a compensation of polarization effects during transmission over light-conducting media, particularly over optical fibers. Such a PMD compensator is known per se from the above-cited article by L. Möller.

In developments of this embodiment, the PMD compensator compensates for distortion in the optical input signal and makes the latter available as a dispersion-compensated optical output signal. The compensation is thus accomplished exclusively with optical means.

In alternative developments, the PMD compensator detects the optical input signal, converts it to an electric signal, compensates for distortion in this signal, and makes the latter available as a dispersion-compensated electric output signal having the data of the optical input signal modulated thereon.

It is also possible to use a hybrid compensator which performs one part of the compensation on the optical signal and another part on the electric signal, and which provides as an output signal a dispersion-compensated electric signal having the data of the optical input signal modulated thereon.

In simple embodiments of the arrangement according to the invention, the PMD compensator is of single-stage construction, as is described, for example, in F. Heismann et al, ECOC '98, Madrid 1998, pp. 529-530. By connecting an optical bandpass filter ahead of a simple single-stage dispersion compensator in accordance with the invention, distortion due to higher-order dispersion effects can be compensated for in a simple manner.

In more complex embodiments of the arrangement according to the invention, the PMD compensator is of multistage construction. With the approach according to the invention, even higher-order distortion in the optical signal can be compensated for with an unchanged level of technical complexity in the compensator.

In a particularly preferred development of the multistage embodiment, at least one stage of the PMD compensator comprises a feedback loop with which the respective stage is so adjusted that a quality signal derived from the output signal of the stage is optimized. In this manner, considerably shorter adaptation times of the dispersion compensator can be achieved in the presence of rapidly varying dispersion distortions in the input signal.

A further considerable improvement can be achieved if in the feedback loop, an optical filter, particularly a bandpass filter, is inserted between the output of the respective stage and a device for deriving the quality signal. The optical prefiltering in the feedback channel permits a substantial improvement in the operating speed and adaptibility of higher-order dispersion compensators with a great number of series-connected stages, and a particularly simple design of such compensators. The operation of such a modified arrangement according the invention is particularly reliable since the feedback signals can be selectively adapted for specific orders of the distortions to be compensated for.

In further developments, the inserted optical filter of the first stage, having a bandwidth narrower than the signal spectrum, passes the inner portions of the optical signal spectrum around the carrier range and filters out the sidebands, so that the first stage is specifically designed for the recovery of the first-order spectral signal component. This may also be advantageous in the case of a single-stage dispersion compensator, for example.

In a particularly advantageous development of the multistage embodiment, the inserted optical filter of the second stage, having a bandwidth narrower than the signal spectrum, filters out the inner portions of the optical signal spectrum around the carrier range and passes only the sidebands. This makes it possible to process specifically the signal components with higher-order distortions.

In another advantageous development, the feedback loop in at least one stage comprises a device for deriving the quality signal which measures the degree of polarization of the output signal of the respective stage and makes it available to an adaptation logic.

The present invention also provides a method of compensating for distortion in an optical signal having data modulated thereon which was caused by dispersion effects on an optical fiber link, using a dispersion compensator which processes the incoming optical signal in such a way that an optical or electric signal having the data of the input signal modulated thereon is provided at its output, with the output signal of the dispersion compensator exhibiting a distortion reduced from that of the input signal. According to the invention, the method is characterized in that prior to the dispersion compensation, the spectral range of the incoming optical signal is limited by means of an optical bandpass filter to a narrower range.

In a particularly advantageous variant of the method according to the invention, a multiple-stage compensation for distortion in the optical signal due to polarization mode dispersion (=PMD) is performed, with higher orders of the PMD being compensated for successively in successive stages, and in at least one stage, a feedback signal is taken from the output of the stage to derive a quality signal therefrom with which the signal compensation of the respective stage is optimized via an adaptation logic. This method of processing signals in multistage compensators can also be used to advantage if prior to the dispersion compensation, no limiting of the spectral range of the incoming optical signal is performed by means of an optical bandpass filter.

In an advantageous development of this variant of the method, the quality signal is derived taking into account the degree of polarization of the output signal of the respective stage, so that different orders of PMD effects can be processed in the various stages.

Also preferred is a variant of the method in which prior to the derivation of the quality signal, the feedback signal is subjected to optical filtering, particularly to bandpass filtering, so that the above-described specific processing of lower and higher orders can be performed in the individual stages.

Also included within the scope of the present invention are a server unit, a processor module, and a gate array module for supporting the above-described method, as well as a computer program for carrying out the method. The method can be implemented both in hardware and in the form of a computer program. Today, software programming is preferred for powerful digital signal processors because new findings and additional functions are easier to implement by modifying the software on an existing hardware basis. However, methods can also be implemented by hardware modules in signal transmission systems, for instance in an IP (=Internet Protocol) network or in a private telecommunications switching system.

### BRIEF DESCRIPTION OF THE DRAWINGS

Further advantages of the invention will become apparent from the following description and the accompanying drawings. According to the invention, the aforementioned features and the features described in the following can be used alone or in arbitrary combinations. While particular embodiments of the invention are described, it is to be understood that the description is made only by way of example and not as a limitation to the scope of the invention.

The invention is illustrated in the accompanying drawings and will now be explained in more detail with the aid of embodiments. In the drawings:

FIG. 1 is a block diagram illustrating the operation of the arrangement according to the invention;

FIG. 2a is a diagrammatic representation of a possible optical bandpass filtering action in an RZ signal spectrum;

FIG. 2b shows a VSB filtering action in an NRZ signal spectrum;

FIG. 3 is a block diagram illustrating the operation of an arrangement with a multistage PMD compensator;

FIG. 4a shows an example of signal processing in the first stage of a feedback loop in which the carrier portion of the signal spectrum is passed and the sidebands are filtered out; and

FIG. 4b shows the signal processing in a further stage in which the carrier portion of the signal spectrum is filtered out and the sidebands are passed.

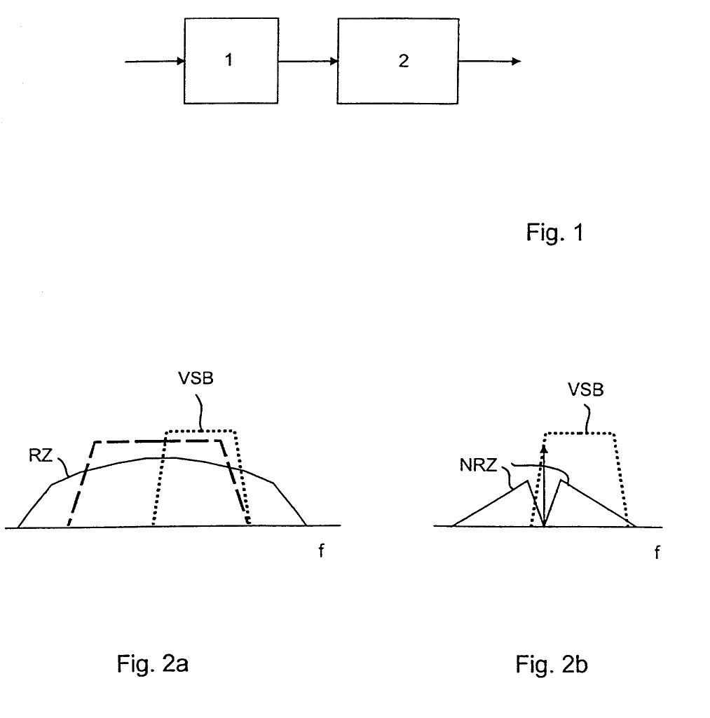

FIG. 1 shows an arrangement according to the invention for compensating for higher-order dispersion effects in an optical signal. In the simplest case, the arrangement comprises an optical bandpass filter 1, in which an incoming optical signal having information modulated thereon is limited to a spectral range narrower than the original range. This filter is followed by a dispersion compensator 2, in which distortions of the optical signal caused by dispersion effects on the optical fiber link are reduced or, if possible, completely removed. Dispersion compensator 2 may operate optically, electrically, or on a hybrid basis.

In most modulation formats, such as NRZ (=non-return-to-zero) or RZ (=return-to-zero), the optical spectrum is wider than the bandwidth necessary for error-free signal detection (bandwidth≅bit rate/2). The basic idea of the present invention is that the optical bandpass filter 1 filters out the unneeded components of the optical signal spectrum, thus blocking “outer” spectral components which were distorted more severely by higher-order dispersion effects. In this manner, the dispersion compensator only needs to handle distortions due to first- and lower-order dispersion effects, which greatly reduces the necessary level of complexity of the compensator with unchanged quality of the output signal.

In FIG. 2a, an RZ-signal spectrum is plotted against the optical frequency f wherein, on the one hand, an NRZ filter positioned symmetrically with respect to the carrier portion of the signal spectrum and, on the other hand, a more narrow-band and asymmetrically positioned VSB filter are used.

In the NRZ-signal spectrum shown schematically in FIG. 2b, the carrier portion and a sideband portion carrying the relevant remainder of the signal information to be transmitted can be filtered out by means of a VSB filter positioned asymmetrically with respect to the center frequency.

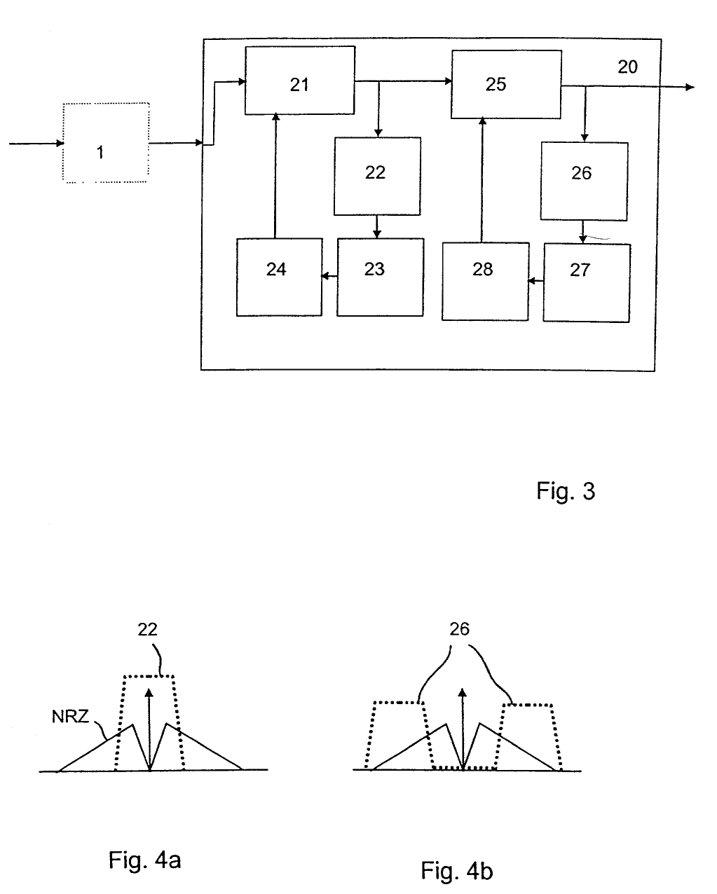

If the distortions due to dispersion effects, particularly to PMD, exceed a specific value, the optical prefiltering in the optical bandpass filter 1 may not suffice for sufficient signal processing. In that case, the dispersion compensator 2 shown in FIG. 1 has to be modified. A preferred development is shown in FIG. 3, where the arrangement according to the invention comprises a two-stage PMD compensator 20. It is possible to use dispersion compensators having even more stages, which can compensate for distortion due to even higher-order dispersion effects.

Furthermore, the arrangement of FIG. 3 shows schematically the use of feedback loops in individual stages of the multistage dispersion compensator 20. In principle, such a feedback loop can also be advantageous in a single-stage compensator.

The first stage of the two-stage dispersion compensator 20 comprises a first-order dispersion compensator 21, from whose output a feedback signal is taken which is bandpass-filtered in a first optical filter 22. The feedback filter 22 passes essentially only spectral components around the central carrier portion of the signal spectrum, which is distorted essentially by first-order dispersion effects. The sidebands are cut off symmetrically with respect to the center frequency of the signal spectrum, as indicated in FIG. 4a. Thus, the first stage of dispersion compensator 20 has to respond only to first-order distortions in the optical signal, and the feedback contrast is not watered down by additional higher-order distortions. As a result, the bandwidth of the first optical filter 22 can be chosen to be quite a bit narrower than, for example, the bandwidth required for the prefiltering in the optical bandposs filter 1.

The filtered optical signal of the first compensation stage is fed to a device 23 for deriving a quality signal, in which, particularly in the case of PMD compensators, the degree of polarization of the output signal from the first dispersion compensator 21 is measured. The output signal from device 23 is provided to an adaptation logic 24, which closes the feedback loop and acts with its output signal on the first dispersion compensator 21 in such a manner that the output signal of the latter is optimized according to predeterminable criteria.

The second stage of dispersion compensator 20, which comprises a second dispersion compensator 25, a second optical filter 26, a second device 27 for deriving a quality signal, and a second adaptation logic 28, operates in a similar manner.

Unlike the first stage, however, the second stage (and any subsequent stages) is to remove distortions due to second- and higher-order dispersion effects from the optical signal. To accomplish this, as indicated in FIG. 4b, the second optical filter 26 filters out the frequency range around the central carrier portion of the spectrum and passes only frequency components that comprise the outer portions of the spectrum and are affected by higher-order distortions. In this manner, a feedback signal specific to the second (and any subsequent) stage can be formed whereby the second dispersion compensator 25 (or a compensator in a subsequent stage) is optimized in its operational behavior to reduce or eliminate correspondingly higher-order distortions.

This principle can also be used successfully without connecting the optical bandpass filter 1 ahead of the multistage dispersion compensator 20.

1. An arrangement for compensating for distortion in an optical signal having data modulated thereon which was caused by dispersion effects on an optical fiber link, comprising a dispersion compensator which processes the incoming optical signal such that an optical or electric signal having the data of the input signal modulated thereon is provided at its output, with the output signal of the dispersion compensator exhibiting a distortion reduced from that of the input signal, wherein that the dispersion compensator is preceded by an optical bandpass filter which limits the spectral range of the incoming optical signal to a narrower range.

2. An arrangement as set forth in claim 1, wherein that the optical bandpass filter is a vestigial-sideband filter which passes only one sideband and the carrier portion of the optical signal.

3. An arrangement as set forth in claim 1, wherein the bandwidth of the vestigial-sideband filter corresponds to approximately half the bit rate of the data modulated on the optical signal.

4. An arrangement as set forth in claim 1, wherein the dispersion compensator can compensate for signal distortion caused by chromatic dispersion.

5. An arrangement as set forth in claim 1, wherein the dispersion compensator is a PMD (=polarization mode dispersion) compensator.

6. An arrangement as set forth in claim 5, wherein the PMD compensator detects the optical input signal, converts it to an electric signal, compensates for distortion in the electric signal, and makes the electric signal available as a dispersion-compensated electric output signal having the data of the optical input signal modulated thereon.

7. An arrangement as set forth in claim 5, wherein the PMD compensator is a hybrid compensator which performs one part of the compensation on the optical signal and another part on the electric signal, and which provides as an output signal a dispersion-compensated electric signal having the data of the optical input signal modulated thereon.

8. An arrangement as set forth in claim 5, wherein at least one stage of the PMD compensator comprises a feedback loop with which the respective stage is so adjusted that a quality signal derived from the output signal of the stage is optimized.

9. An arrangement as set forth in claim 8, wherein in the feedback loop, an optical filter, particularly a bandpass filter, is inserted between the output of the stage and a device for deriving the quality signal.

10. An arrangement as set forth in claim 9, wherein the inserted optical filter of the first stage, having a bandwidth narrower than the signal spectrum, passes the inner portions of the optical signal spectrum around the carrier range and filters out the sidebands.

11. An arrangement as set forth in claim 9, wherein the inserted optical filter of the second stage, having a bandwidth narrower than the signal spectrum, filters out the inner portions of the optical signal spectrum around the carrier range and passes only the sidebands.

12. A method of compensating for distortion in an optical signal having data modulated thereon which was caused by dispersion effects on an optical fiber link, using a dispersion compensator which processes the incoming optical signal in such a way that an optical or electric signal having the data of the input signal modulated thereon is provided at its output, with the output signal of the dispersion compensator exhibiting a distortion reduced from that of the input signal, wherein prior to the dispersion compensation, the spectral range of the incoming optical signal is limited to a narrower range by means of an optical bandpass filter.

13. A method as set forth in claim 18, wherein a multiple-stage compensation for distortion in the optical signal caused by polarization mode dispersion (=PMD) is performed, with higher orders of the PMD being compensated for successively in successive stages, and that in at least one stage, a feedback signal is taken from the output of the stage to derive a quality signal therefrom with which the signal compensation of the respective stage is optimized via an adaptation logic.

14. A method as set forth in claim 17, wherein the quality signal is derived taking into account the degree of polarization of the output signal of the respective stage.

16. A method as set forth in claim 17 or 18, wherein prior to the derivation of the quality signal, the feedback signal is subjected to optical filtering, particularly to bandpass filtering.

17. A processor module, particularly a digital signal processor, for supporting the method set forth in claim 12.

18. A programmable gate array module for supporting the method set forth in claim 12.

19. A computer program for carrying out the method set forth in claim 12.
